(19) United States
(12) Patent Application Publication
(10) Pub. No.: US 2025/0310545 A1
(43) Pub. Date: Oct. 2, 2025

(54) METHOD AND APPARATUS FOR SEMANTIC BASED LEARNED IMAGE COMPRESSION

(71) Applicant: Huawei Technologies Co., Ltd., Shenzhen (CN)

(72) Inventors: Wei Wang, San Jose, CA (US); Yue Chen, Saratoga, CA (US)

(21) Appl. No.: 19/233,892

(22) Filed: Jun. 10, 2025

Related U.S. Application Data
(63) Continuation of application No. PCT/US2023/085773, filed on Dec. 22, 2023.
(60) Provisional application No. 63/434,787, filed on Dec. 22, 2022.

(51) Int. Cl. H04N 19/17; H04N 19/13; H04N 19/132; H04N 19/70; H04N 19/88

(52) U.S. Cl. CPC H04N 19/17; H04N 19/13; H04N 19/132; H04N 19/70; H04N 19/88

(57) ABSTRACT

A method of image compression implemented by a coding device. The method comprises receiving an input latent image comprising latent image patches containing latent image data, selecting a subset of the latent image patches; applying the latent image patches to the input of a first encoder in the coding device, receiving conditioning side information, encoding, by the first encoder, the subset of latent image patches based on the conditioning side information to generate encoded latent image patches. The method further includes combining the encoded latent image patches with a plurality of mask tokens, applying the combined encoded latent image patches and plurality of mask tokens to the input of a decoder in the coding device, decoding the combined encoded latent image patches and plurality of mask tokens based on the conditioning side information to generate a reconstructed latent feature map, and rearranging the reconstructed latent feature map to produce an output latent image.

### CROSS-REFERENCE TO RELATED APPLICATIONS

This is a continuation of International Application No. PCT/US2023/085773, filed Dec. 22, 2023, entitled “Method and Apparatus for Semantic Based Learned Image Compression,” which claims the benefit of U.S. Provisional Patent No. 63/434,787, filed Dec. 22, 2022, entitled “SEMANTIC BASED LEARNED IMAGE COMPRESSION, all of which are hereby incorporated by reference in its entirety.

### BACKGROUND

Image compression plays an important role in reducing image storage and transmission bandwidth requirements. Image compression standards (e.g., JPEG, JPEG2000) have been developed and are used in a wide variety of applications. Also, some video compression standards (e.g., H.265/HEVC, H.266/VVC) also developed still image profiles to support efficient image compression. These standards are based on traditional coding framework, which includes image partition, intra prediction, transformation, quantization, context modelling, lossless entropy coding and loop filter to exploit the spatial, visual, and statistical redundancy in images.

### SUMMARY

A first aspect relates to a method of image processing implemented by a coding device. The method comprises i) receiving an input latent image comprising latent image patches containing latent image data, ii) selecting a subset of the latent image patches; iii) applying the latent image patches to the input of a first encoder in the coding device, iv) receiving conditioning side information; v) encoding, by the first encoder, the subset of latent image patches based on the conditioning side information to generate encoded latent image patches. The method further includes vi) combining the encoded latent image patches with a plurality of mask tokens, vii) applying the combined encoded latent image patches and plurality of mask tokens to the input of a decoder in the coding device, viii) decoding, by the decoder, the combined encoded latent image patches and plurality of mask tokens, optionally based on the conditioning side information to generate a reconstructed latent feature map, and ix) rearranging the reconstructed latent feature map to produce an output latent image.

Optionally, in the preceding aspect, another implementation of the aspect includes wherein the input latent image comprises a latent image tensor received from a second encoder.

Optionally, in any of the preceding aspects, another implementation of the aspect includes wherein the input latent image comprises N latent image patches arranged in a two-dimensional (2D) array.

Optionally, in any of the preceding aspects, another implementation of the aspect includes wherein the 2D array is an M×M array.

Optionally, in any of the preceding aspects, another implementation of the aspect includes wherein selecting the subset of the latent image patches comprises masking out, by the first decoder, a plurality of the latent image patches in the M×M array.

Optionally, in any of the preceding aspects, another implementation of the aspect includes wherein applying the latent image patches to the input of the first encoder comprises applying unmasked latent image patches to the input of the first encoder.

Optionally, in any of the preceding aspects, another implementation of the aspect includes wherein the conditioning side information comprises semantic information.

Optionally, in any of the preceding aspects, another implementation of the aspect includes wherein the conditioning side information comprises at least one of text data, image data, or a semantic map.

Optionally, in any of the preceding aspects, another implementation of the aspect includes wherein the conditioning side information comprises at least one of representation data, confidence ratio data, or an anchor mask, or other information that represents the semantic information of input image.

A second aspect relates to an apparatus for processing images comprising a storage device and one or more processors coupled to the storage device and configured to execute instructions on the storage device such that when executed, cause the apparatus to i) receive an input latent image comprising latent image patches containing latent image data, ii) select a subset of the latent image patches, iii) apply the latent image patches to an input of a first encoder in the apparatus, iv) receive conditioning side information; v) encode, by the first encoder, the subset of latent image patches based on the conditioning side information to generate encoded latent image patches. The instructions further cause the apparatus to vi) combine the encoded latent image patches with a plurality of mask tokens, vii) apply combined encoded latent image patches and plurality of mask tokens to an input of a decoder in the apparatus, viii) decode the combined encoded latent image patches and plurality of mask tokens based on the conditioning side information to generate a reconstructed latent feature map; and ix) rearrange the reconstructed latent feature map to produce an output latent image.

Optionally, in the preceding aspect, another implementation of the aspect includes wherein the input latent image comprises a latent image tensor received from a second encoder.

Optionally, in any of the preceding aspects, another implementation of the aspect includes wherein the input latent image comprises N latent image patches arranged in a two-dimensional (2D) array.

Optionally, in any of the preceding aspects, another implementation of the aspect includes wherein the 2D array is an M×M array.

Optionally, in any of the preceding aspects, another implementation of the aspect includes wherein the apparatus selects the subset of the latent image patches by masking out, by the first decoder, a plurality of the latent image patches in the M×M array.

Optionally, in any of the preceding aspects, another implementation of the aspect includes wherein the apparatus applies the latent image patches to the input of the first encoder by applying unmasked latent image patches to the input of the first encoder.

Optionally, in any of the preceding aspects, another implementation of the aspect includes wherein the conditioning side information comprises semantic information.

Optionally, in any of the preceding aspects, another implementation of the aspect includes wherein the conditioning side information comprises at least one of text data, image data, or a semantic map.

Optionally, in any of the preceding aspects, another implementation of the aspect includes wherein the conditioning side information comprises at least one of representation data, confidence ratio data, or an anchor mask, or other information that represents the semantic information of input image.

A third aspect relates to a network device for communication between nodes, comprising a storage device and one or more processors coupled to the storage device and configured to execute instructions on the storage device. When executed, the instructions cause the one or more processors to: i) receive an input latent image comprising latent image patches containing latent image data, ii) select a subset of the latent image patches, iii) apply the latent image patches to an input of a first encoder in the network device, iv) receive conditioning side information; v) encode, by the first encoder, the subset of latent image patches based on conditioning side information received by the first encoder to generate encoded latent image patches. When executed, the instructions cause the one or more processors to vi) combine the encoded latent image patches with a plurality of mask tokens, vii) apply the combined encoded latent image patches and plurality of mask tokens to an input of a decoder in the network device, vii) decode, by the decoder, the combined encoded latent image patches and plurality of mask tokens based on the conditioning side information to generate a reconstructed latent feature map, and viii) rearrange the reconstructed latent feature map to produce an output latent image.

Optionally, in the preceding aspect, another implementation of the aspect includes wherein the input latent image comprises a latent image tensor received from a second encoder.

Optionally, in any of the preceding aspects, another implementation of the aspect includes wherein the input latent image comprises a latent image tensor received from a second encoder.

Optionally, in any of the preceding aspects, another implementation of the aspect includes wherein the input latent image comprises N latent image patches arranged in a two-dimensional (2D) array.

Optionally, in any of the preceding aspects, another implementation of the aspect includes wherein the network device selects the subset of the latent image patches by masking out, by the first encoder, a plurality of the latent image patches in the 2D array.

Optionally, in any of the preceding aspects, another implementation of the aspect includes wherein the conditioning side information comprises semantic information.

Optionally, in any of the preceding aspects, another implementation of the aspect includes wherein the conditioning side information comprises at least one of text data, image data, or a semantic map, or other information that represents the semantic information of the input latent image.

A fifth aspect relates to a method of image processing implemented by a coding device. The method comprises: i) receiving in the coding device a bitstream of hyper encoded image data from a single hyper encoder; ii) generating, by the coding device, a reconstructed tensor from the bitstream; iii) generating, by the coding device, conditioning side information using each of a plurality of hyper decoders; and iv) transmitting the conditioning side information to a processing unit of the coding device, wherein the processing unit is configured to generate an image for display using the conditioning side information.

Optionally, in the preceding aspect, another implementation of the aspect includes wherein the conditioning side information includes at least one of a latent feature, a confidence ratio value, an anchor mask, or other information that represents the semantic information of the input image.

A sixth aspect relates to an apparatus for processing images. The apparatus comprises: i) a storage device; and ii) one or more processors coupled to the storage device and configured to execute instructions on the storage device such that when executed, the instructions cause the apparatus to: receive in the apparatus a bitstream of hyper encoded image data from a single hyper encoder; generate a reconstructed tensor from the bitstream; generate conditioning side information using each of a plurality of hyper decoders; and transmit the conditioning side information to a processing unit of the main decoder, wherein the processing unit is configured to generate an image for display using the conditioning side information.

Optionally, in the preceding aspect, another implementation of the aspect includes wherein the conditioning side information includes at least one of a latent feature, a confidence ratio value, an anchor mask, or other information that represents the semantic information of the input image.

A seventh aspect relates to a method of image processing implemented by a main decoder. The method comprises: i) receiving a latent image tensor in the main decoder; ii) generating a representation string comprising semantic information from the latent image tensor; iii) quantizing, decoding, and concatenating the representation string to generate a reconstructed latent image tensor; and iv) transmitting the reconstructed latent image tensor to a processing unit of the main decoder, wherein the processing unit is configured to generate an image for display using the conditioning side information.

An eighth aspect relates to an apparatus for processing images, comprising i) a storage device; and ii) one or more processors coupled to the storage device and configured to execute instructions on the storage device such that when executed, the instructions cause the apparatus to: iii) receive a latent image tensor in a main decoder of the apparatus; iv) generate a representation string comprising semantic information from the latent image tensor; v) quantize, decode, and concatenate the representation string to generate a reconstructed latent image tensor; and vi) transmit the reconstructed latent image tensor to a processing unit of the main decoder, wherein the processing unit is configured to generate an image for display using the conditioning side information.

A ninth aspect relates to a method of image processing implemented by a decoder. The method comprises: i) receiving a latent image tensor in the decoder; ii) in a first reverse diffusion iteration, a) processing the latent image tensor in a first cross-attention module of a first denoising U-Net module to generate a first denoising U-Net module output tensor; b) processing the first denoising U-Net module output tensor in a first processing unit of the first denoising U-Net module to perform entropy decoding and generate a first reconstructed latent image tensor and first conditioning side information; c) processing the first denoising U-Net module output tensor in a second cross-attention module of a second denoising U-Net module to generate a second denoising U-Net module output tensor; d) processing the second denoising U-Net module output tensor in a second processing unit of the second denoising U-Net module to perform entropy decoding and generate a second reconstructed latent image tensor and second conditioning side information; and e) denoising the second reconstructed latent image tensor to produce a first denoised output tensor. The method further includes, in a second reverse diffusion iteration, a) processing the first denoised output tensor in the first cross-attention module of a first denoising U-Net module to generate a third denoising U-Net module output tensor; b) processing the third denoising U-Net module output tensor in the first processing unit of the first denoising U-Net module to generate a third reconstructed latent image tensor and third conditioning side information; c) processing the third denoising U-Net module output tensor in the second cross-attention module of the second denoising U-Net module to generate a fourth denoising U-Net module output tensor; d) processing the fourth denoising U-Net module output tensor in the second processing unit of the second denoising U-Net module to generate a fourth reconstructed latent image tensor and fourth conditioning side information; and e) denoising the fourth reconstructed latent image tensor to produce a second denoised output tensor; and f) transmit the second denoised output tensor to a processing unit of the decoder, wherein the processing unit of the main decoder is configured to generate an image for display using at least one of the first, second, third and fourth conditioning side information.

A tenth aspect relates to an apparatus for processing images, comprising: a storage device; and one or more processors coupled to the storage device and configured to execute instructions on the storage device. When executed, the instructions cause the apparatus to: i) receive a latent image tensor in the apparatus; in a first reverse diffusion iteration, ii) process the latent image tensor in a first cross-attention module of a first denoising U-Net module to generate a first denoising U-Net module output tensor; iii) process the first denoising U-Net module output tensor in a first processing unit of the first denoising U-Net module to perform entropy decoding and generate a first reconstructed latent image tensor and first conditioning side information; iv) process the first denoising U-Net module output tensor in a second cross-attention module of a second denoising U-Net module to generate a second denoising U-Net module output tensor; v) process the second denoising U-Net module output tensor in a second processing unit of the second denoising U-Net module to perform entropy decoding and generate a second reconstructed latent image tensor and second conditioning side information; and vi) denoise the second reconstructed latent image tensor to produce a first denoised output tensor; in a second reverse diffusion iteration, vii) process the first denoised output tensor in the first cross-attention module of a first denoising U-Net module to generate a third denoising U-Net module output tensor; viii) process the third denoising U-Net module output tensor in the first processing unit of the first denoising U-Net module to generate a third reconstructed latent image tensor and third conditioning side information; ix) process the third denoising U-Net module output tensor in the second cross-attention module of the second denoising U-Net module to generate a fourth denoising U-Net module output tensor; x) process the fourth denoising U-Net module output tensor in the second processing unit of the second denoising U-Net module to generate a fourth reconstructed latent image tensor and fourth conditioning side information; and xi) denoise the fourth reconstructed latent image tensor to produce a second denoised output tensor; and xii) transmit the second denoised output tensor to a processing unit of the decoder, wherein the processing unit of the main decoder is configured to generate an image for display using at least one of the first, second, third and fourth conditioning side information.

A fourth aspect relates to a non-transitory computer readable medium comprising a computer program product for use by a network node, the computer program product comprising computer executable instructions stored on the non-transitory computer readable medium that, when executed by one or more processors, cause the network node to execute the method of the preceding aspects.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a flow diagram of learned image compression according to an embodiment of the disclosure.

FIG. 2 is a block diagram of a main encoder according to an embodiment of the disclosure.

FIG. 3 is a block diagram of a main decoder according to an embodiment of the disclosure.

FIGS. 4A-4E illustrate examples of mask convolution-based context models according to an embodiment of the disclosure.

FIG. 5 illustrates a learned image compression framework according to an embodiment of the disclosure.

FIG. 6A illustrates a guided latent masked autoencoder (MAE) context model according to an embodiment of the disclosure.

FIG. 6B is a flow diagram of an image processing method implemented by a coding device according to an embodiment of the disclosure.

FIGS. 7A-7B illustrate hyper encoder and hyper decoder pairs that produce side information according to an embodiment of the disclosure.

FIG. 8 illustrates a representation-based U-Net structure in a learned image compression framework according to an embodiment of the disclosure.

FIG. 9 illustrates a representation diffusion U-Net framework according to an embodiment of the disclosure.

FIG. 10 is a schematic diagram of a routing device 1000 according to an embodiment of the disclosure.

### DETAILED DESCRIPTION

The present disclosure relates to a method of learned image compression. More specifically, the method is related to improving coding efficiency by utilizing one or more techniques, such as a latent channel reorder, a channel-shuffling context model, a semantic variational autoencoder (VAE) framework, a guided masked autoencoder (MAE) context model, a representation U-Net framework, or a representation diffusion U-Net framework.

The rapid progress of deep learning research has led to the development of deep learned image compression utilizing many state-of-the-art deep learning techniques. An example autoregressive scale hyperprior framework of learned image compression may use a variational autoencoder (VAE) as a main encoder to process the latent information of an input image and use a hyperprior model as a hyper encoder to process additional hyper latent information. An example framework may also use an autoregressive model as context modelling to process the spatial relationship among neighbor latent coefficients and a Gaussian mixture model (GMM) or Gaussian scale mixture (GSM) to generate the mean and scale associated with each latent coefficient.

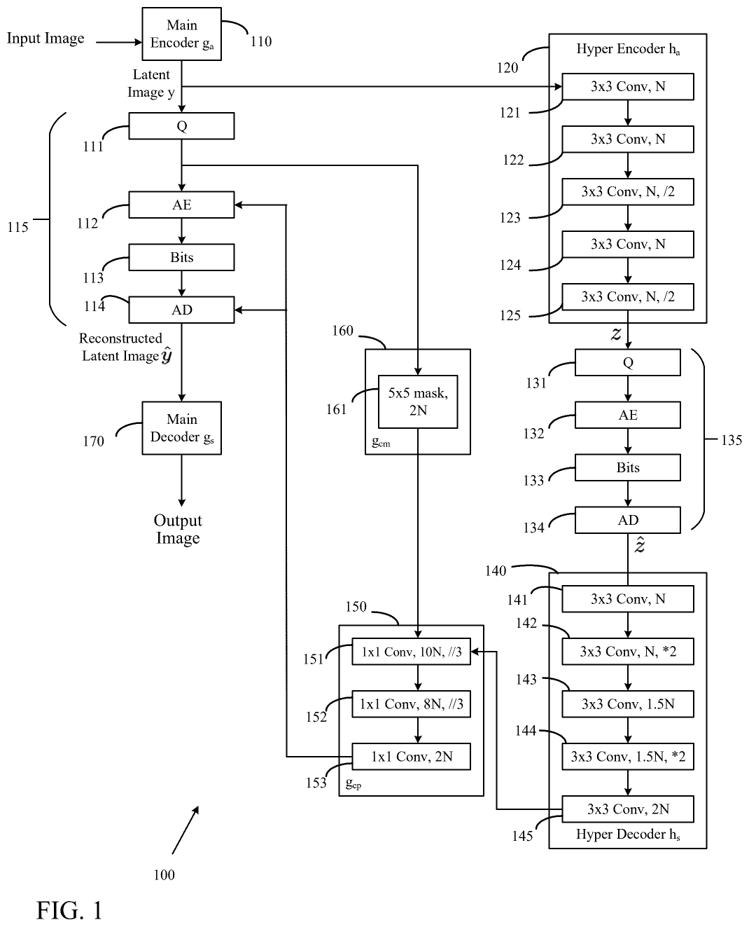

FIG. 1 is a flow diagram of a learned image compression system 100 according to an embodiment of the disclosure. The system 100 is a conventional architecture that includes a main encoder (ga) 110, a hyper encoder (ha) 120, a processing unit 135, a hyper decoder (hs) 140, an entropy parameter module (gep) 150, a context model (gcm) 160 (including a 5×5 mask 161), a processing unit 115, and a main decoder (gs) 170. Processing unit 135 includes quantization (Q) layer 131, arithmetic encoder (AE) 132, a bitstream 133, and an arithmetic decoder (AD) 134. Processing unit 115 includes a quantization (Q) layer 111, an arithmetic encoder (AE) 112, a bitstream 113, and an arithmetic decoder (AD) 114.

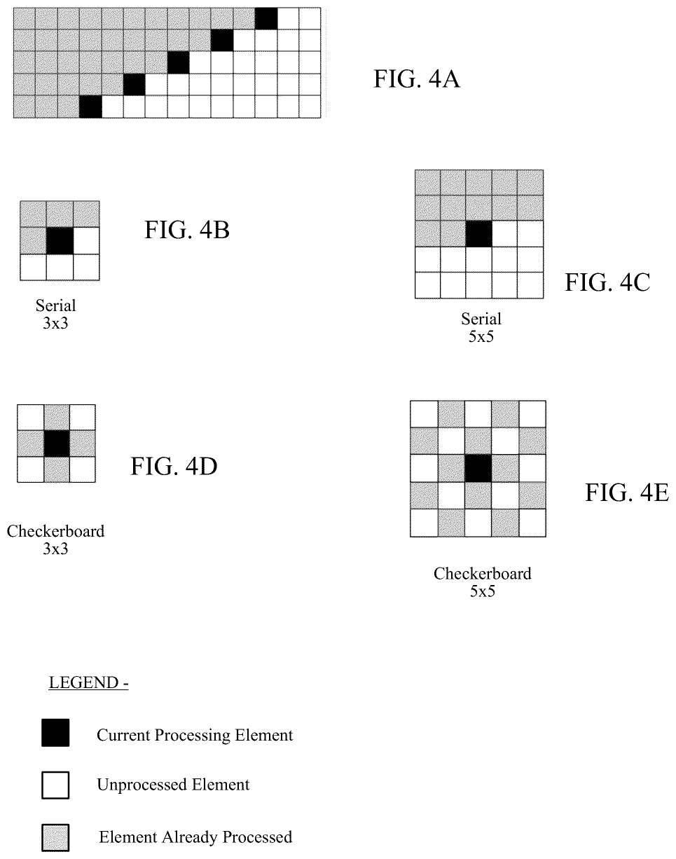

Context model 160 is a masked convolution layer, usually a 3×3 or 5×5 convolution or a 5×5. For a 3×3 convolution, the shape of its mask is FIG. 4B. For a 5×5 convolution, the shape of its mask is FIG. 4C. Its input channel number is N and output channel number is 2N. Entropy parameter module (gep) 150 estimates gaussian parameters of AE 112 and AD 114. Entropy parameter module (gep) 150 includes three (3) 1×1 convolution layers 151-153. The input channel for the first convolution layer 151 is 4N and the output of the last convolution layer 153 is 2N.

Hyper encoder 120 includes convolution layers 121-125. Hyper decoder 140 includes convolution layers 141-145. Hyper decoder output contains an initial prediction of gaussian parameters (gaussian mean, and gaussian scale). The output is concatenated with the output of context model (gcm) 160 and used as the input of entropy parameter module (gep) 150 to generate final prediction of gaussian parameters.

Entropy parameter module (gep) 150 includes convolution layers 151-153. The text within the convolution layers indicates the convolution size (M×M), the output channel number (N), and a math operator indicating up-sampling or down-sampling. The math operators are regular division (“/”), multiplication (“*”), and floor division (“//”). Floor division rounds down to the nearest integer after the division operation. For example, the text “3×3 Cony, N, /2” in convolution layer 123 indicates a 3×3 convolution on output channel N and the tensor is down-sampled by 2. Similarly, the text “3×3 Cony, N” in convolution layer 124 indicates a 3×3 convolution on output channel N and the tensor is neither up-sampled nor down-sampled because no math operator is present. Also, the text “1×1 Cony, ION, //3” in convolution layer 151 indicates a 1×1 convolution operation on output channel ION and the tensor is down-sampled to an integer value obtained by dividing by 3 and rounding down to the integer value.

Main encoder 110 receives an input image and generates a tensor, latent image y, at the output of main encoder 110. Processing unit 115 receives the latent image y and generates a tensor, reconstructed latent image f, at the output of processing unit 115. Hyper encoder 120 receives latent image y at the output of main encoder 110 and generates a tensor, z, at the output of hyper encoder 120. Processing unit 135 receives the tensor z and generates a tensor 2, at the output of processing unit 135.

Hyper decoder 140 receives the tensor 2 at the output of processing unit 135 and generates an output tensor at the output of hyper decoder 140. Context model 160 receives the output of quantization layer 111 and applies a 5×5 mask on output channel 2N. Entropy parameter module (gep) 150 receives the output of context model 160 and also the output of hyper decoder 140 and generates a tensor output that is applied to arithmetic encoder 112, and arithmetic decoder 114. Finally, the main decoder 170 receives the output of processing unit 115, reconstructed latent image f, and generates a final output image at the output of main decoder 170.

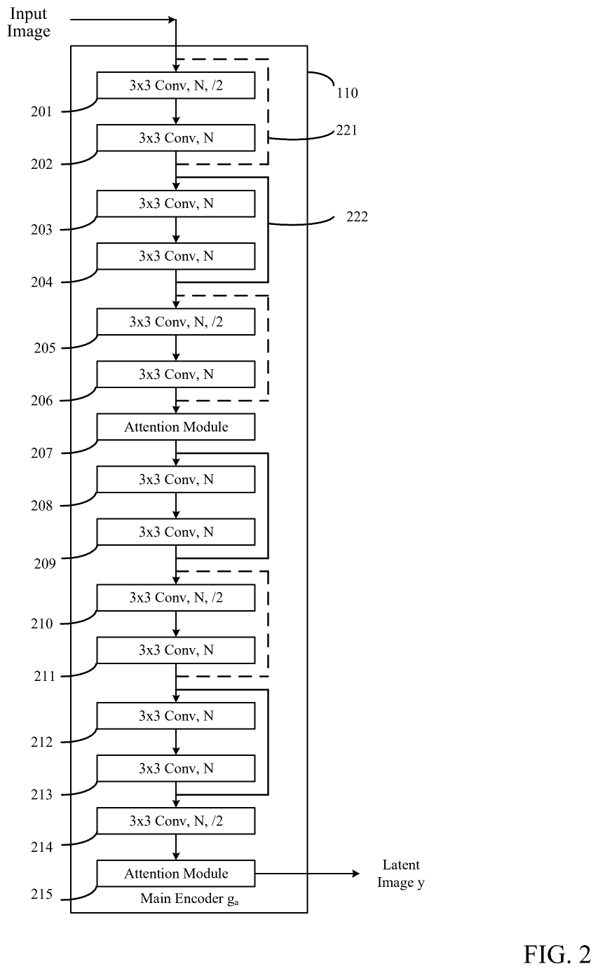

FIG. 2 is a block diagram of the main encoder 110 in FIG. 1 according to an embodiment of the disclosure. The example main encoder 110 includes convolution layers 201-214 and attention module 215. In an image classification task, the attention module 215 helps the model to focus on the most relevant regions of the image that contain the object of interest and ignore the background or other distractions. The main encoder 110 also includes multiple residual shortcuts, including example residual shortcuts 221 (dotted line) and 222 (solid line). The residual shortcuts help merge features from different resolution levels, thereby enhancing the ability of the model to capture fine details. As in FIG. 1, the text within the convolution layers 201-214 indicates the convolution size (M×M), the output channel number (N), and a math operator indicating up-sampling or down-sampling.

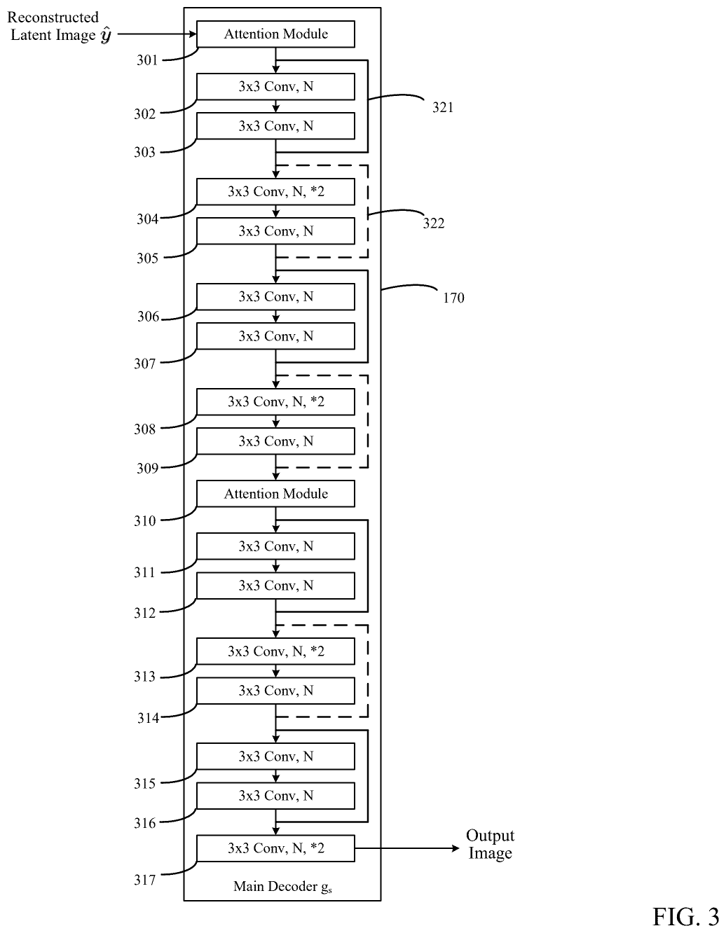

FIG. 3 is a block diagram of a main decoder 170 in FIG. 1 according to an embodiment of the disclosure. The example main decoder 170 includes convolution layers 302-309 and 311-317 and attention modules 301 and 310. As in FIG. 2, the attention modules 301 and 310 focuses the model on the most relevant regions of the image. The main encoder 110 also includes multiple residual shortcuts, including example residual shortcuts 321 (solid line) and 322 (dotted line). As in FIGS. 1 and 2, the text within the convolution layers 302-309 and 311-317 indicates the convolution size (M×M), the output channel number (N), and a math operator indicating up-sampling or down-sampling.

FIGS. 4A-4E illustrate examples of mask convolution-based context models according to an embodiment of the disclosure. FIG. 4B illustrates a 3×3 serial mask convolution. FIG. 4C illustrates a 5×5 serial mask convolution. FIG. 4D illustrates a 3×3 checkerboard mask convolution. FIG. 4E illustrates a 5×5 checkerboard mask convolution. In FIGS. 4A-4E, unprocessed elements are depicted as white squares, processed elements are depicted as gray squares, and currently processed elements are depicted as black squares.

Context modelling is a technique used extensively in traditional video coding frameworks. It is a process to predict a current pixel value based on pixels that have already been decoded. In a deep learning framework, a mask convolution is usually used to achieve the same function. In a serial context model (i.e., FIG. 4A), coefficients are predicted and encoded one at a time using a raster scan order. During the prediction process, a mask is defined to force kernel values corresponding to yet-to-processed locations to zero (i.e., white squares). Coefficients cannot be processed in parallel due to the sequential nature of the autoregressive process and raster scan order used in serial context model.

In a wavefront context model (i.e., FIG. 4A), coefficients are predicted and encoded in a wavefront fashion. During the prediction process, the same mask for serial context model is used to force kernel values corresponding to yet-to-processed locations to zero. A wavefront context model achieves moderate parallelism by decreasing processing time from W*H in serial context model to W+H.

In a checkerboard context model, coefficients are divided into two groups using a checkerboard pattern. During the prediction process, a mask with a checkerboard pattern is defined to force kernel values corresponding to yet-to-processed locations to zero, so that a second group of coefficients can be predicted using the first group of coefficients. A checkerboard context model allows predicting of second group coefficients in parallel and results in very high parallelism.

In channel-grouping context model, the latent tensor is divided along channel dimensions to form multiple tensors with the same or different shape. These tensors are predicted one at a time during the prediction process.

Coding efficiency is not fully exploited by many conventional learned image compression frameworks. For example, two latent channels with a strong correlation may not be adjacent to each other, resulting in poor prediction efficiency of context models. Multi-modal semantic side information may be poorly utilized. Fix-shape mask convolution-based context model cannot adapt to the content of a latent tensor. The information loss from autoencoder down-sampling process cannot be recovered efficiently. The use of autoencoder structure is not fully exploited either.

The present disclosure describes several techniques to improve coding efficiency of learned image compression frameworks, including latent channel reordering, channel-shuffling context models, semantic variational autoencoder (VAE) frameworks, guided masked autoencoder (MAE) context models, a representation U-Net framework, or a representation diffusion U-Net framework.

### Latent Channel Reorder—

Since there are no special constraints on minimizing correlations among adjacent latent channels of latent image y at the output of main encoder 110 during the training process, it may be observed that two latent channels with a strong correlation may not be adjacent to each other. This may cause problems for context modeling because the prediction efficiency of context models is heavily dependent on the correlation relationships among channels. However, it may also be observed that the correlation relationships among latent channels are relatively fixed regardless of the different distribution of different input images. This provides the present disclosure an opportunity to improve the prediction efficiency of context models by reordering the latent channels of latent image y of main encoder 110. Since the convolution layer and the fully connected layer may both be implemented by matrix multiplication operation that outputs a latent tensor, the present disclosure reorders the latent channels by utilizing the mathematical property of matrix multiplication.

For matrix multiplication,

$$L * R = O .$$

By swapping two rows in the matrix L, a new output Onew can be obtained by swapping corresponding rows in the original matrix O. Swapping two rows in matrix R and swapping two corresponding columns in matrix L at the same time results in the new output Onew being equal to original matrix O.

The present disclosure defines a correlation score (MSE, MS-SSIM, etc.), then calculates correlation scores among all channels of the latent tensor y at the main encoder 110 output. The present disclosure then determines a preferred number of channel groups and preferred channel order within each channel group based on a selection criterion and reorders each channel group with its preferred channel order.

Assuming latent tensor y is generated using a convolution or fully connected layer and the generating operation can be represented by matrix multiplication, then W*A=y, where W is a reshaped convolution or fully connected layer and A is the input activation tensor. In one embodiment, the reordered tensor, yrod, can be generated by simply reordering the rows of latent tensor y using preferred channel order on the fly. In another embodiment, the reordered tensor yrod can be generated by inserting an additional operation, I*y, after the convolution or fully connected layer, where the matrix I is an identity matrix with rows reordered using preferred channel order. In still another embodiment, the reordered tensor yrod can be generated by reordering the rows of tensor W using preferred channel order.

After the new tensor is generated, a system according to the principles of the present disclosure may freeze the main encoder 110 and fine-tune the rest of the network to recover the network performance. Alternatively, a system according to the present disclosure can restore the channel order of [symbol] to its original order so that the main decoder 110 can be frozen during the fine-tuning process as well. To keep the main decoder 170 frozen during the fine-tuning process, assuming the latent tensor [symbol] is the input activation tensor of a convolution or fully connected layer, and the operation can be represented by matrix multiplication, then W* [symbol] =O, where W is reshaped convolution or fully connected layer and O is the output tensor.

In one embodiment, the restored tensor [symbol] may be generated by simply restoring the rows of tensor [symbol] using preferred channel order on the fly. The tensor O may be kept unchanged because this operation cancelled out the reordering operation of latent image y at the encoder side. In another embodiment, the restored tensor [symbol] may be generated by inserting an additional operation I* [symbol] before the convolution or fully connected layer, where matrix I is an identity matrix with columns reordered using preferred channel order. The tensor O may be kept unchanged because this operation cancelled out the reordering operation of latent image y at the encoder side. In another embodiment, the restored tensor Ores can be generated by keeping [symbol] unchanged but reordering the columns of tensor W using a preferred channel order.

### Channel-Shuffling Context Model—

The present disclosure uses a channel-grouping context modelling method to predict all channel groups. The channel groups may be processed in parallel or sequentially where previously encoded group or groups may be used as conditional information to predict current channel group. Because it is difficult to predict along a channel dimension without channel reorder method, the prediction accuracy along channel dimension may be poor for serial, wavefront, and checkerboard context models. To address this, the system 100 may include an additional channel-shuffling context model before or after serial, wavefront, and checkerboard context models. A channel-shuffling context model may be performed on one or more channel groups, where one or more channels in a selected group are chosen as a reference and prediction of the rest of the channels is performed along the channel dimension to determine the reordered correlation among channels in this group. The output of a previous module may be used as an additional input for the channel-shuffling context model.

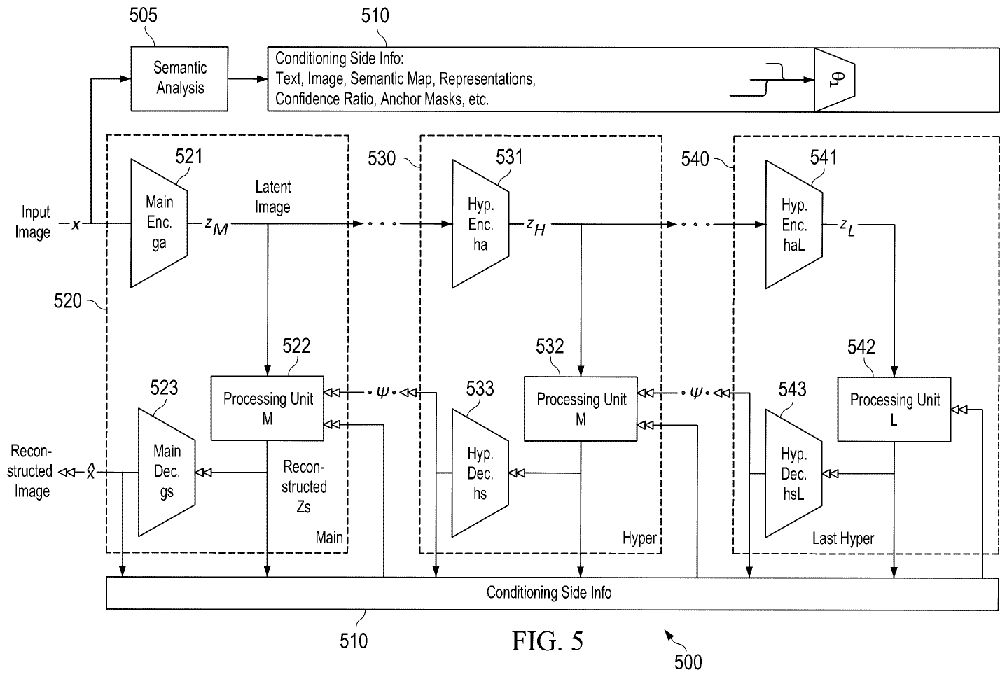

FIG. 5 illustrates a learned image compression framework 500 according to an embodiment of the disclosure. It includes a main encoder/decoder pair 520 and one or more hyper encoder/decoder pairs, including a first hyper encoder/decoder pair 530 and a last hyper encoder/decoder pair 540. The main encoder/decoder pair 520 includes a main encoder (ga) 521, a processing unit 522, and a main decoder (gs) 523. The first hyper encoder/decoder pair 530 includes a hyper encoder (ha) 531, a processing unit 532, and a hyper decoder (hs) 533. The last hyper encoder/decoder pair 540 includes a hyper encoder (haL) 541, a processing unit 542, and a hyper decoder (hsL) 543.

The main encoder (ga) 521 receives image x as an input and generates a latent tensor zM with spatially varying standard deviations. If multiple hyper encoder/decoder pairs are used to further process the correlations of zM, the first hyper encoder 531 receives zM as an input and generates a latent tensor zH with spatially varying standard deviations and the remaining hyper encoders (ha) (except for the last hyper encoder (haL) 541) take the output of the previous hyper encoder zH as an input and generates its own latent tensor output zH with spatially varying standard deviations. The last hyper encoder (haL) 541 takes the last zH (if multiple hyper encoders are used) or zM (if only one hyper encoder is used) as input and generates the final latent tensor zL with the distribution of standard deviations.

According to the principles of the present disclosure, the framework 500 further includes conditioning side information 510 that is extracted by semantic analysis module 505. Semantic analysis module 505 receives the input image x and processes the input image x to extract conditioning side information 510 (also called semantic side information 510), such as text, image, semantic representations, segmentation maps, anchor masks, confidence ratios, and the like. A domain specific encoder τ_{θ} is used to map some or all semantic information to one or more intermediate representations τ_{θ}. The conditioning side information 510 may be used as additional inputs to both the encoder and decoder in each stage.

The processing units 522, 532, and 542 are similar to the processing units 115 and 135 in FIG. 1. Each of the processing units 522, 532, 542 receives as an input conditioning side information 510 and also outputs conditioning side information 510. Each of the processing units also receives as an input the output (Ψ) of the decoder 523, 533, 543 from the previous stage in FIG. 5. The final main decoder 523 outputs a reconstructed image x.

The conditioning side information 510 represents senses that are meaningful for a system 100. This is different from correlational information, which is a relationship among coefficients close to each other. Conditioning side information 510 is important in deep learning research, especially in the area of large-scale language models, vision models, multi-modal image-to-text models, and text-to-image models. It is also a foundation for multiple deep learning methods such as contrastive learning and representation learning.

For example, multi-modal text-to-image models are widely used in generative vision tasks. For example, the contrastive language-image pretraining (CLIP) jointly trains an image encoder and a text encoder using contrastive language-image training method to predict matching image and text pairs. A dataset classifier is generated from label text. Then, for any input image at the test stage, the image encoder and the text encoder work together to generate a zero-shot linear classifier by embedding the names or descriptions of the classes of the target dataset. The representation of semantic information of the text can be used for downstream tasks.

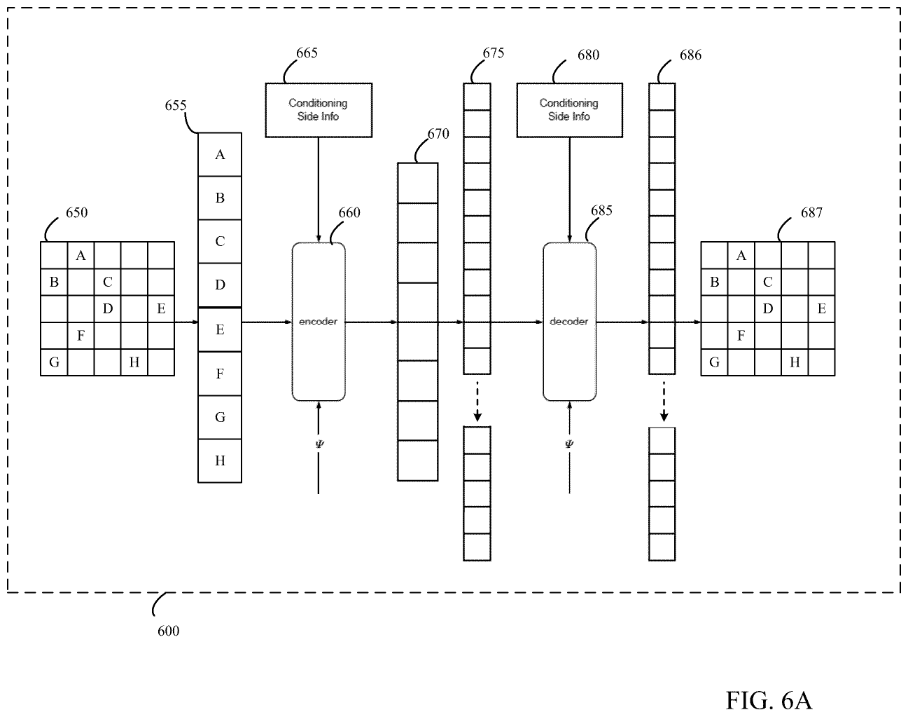

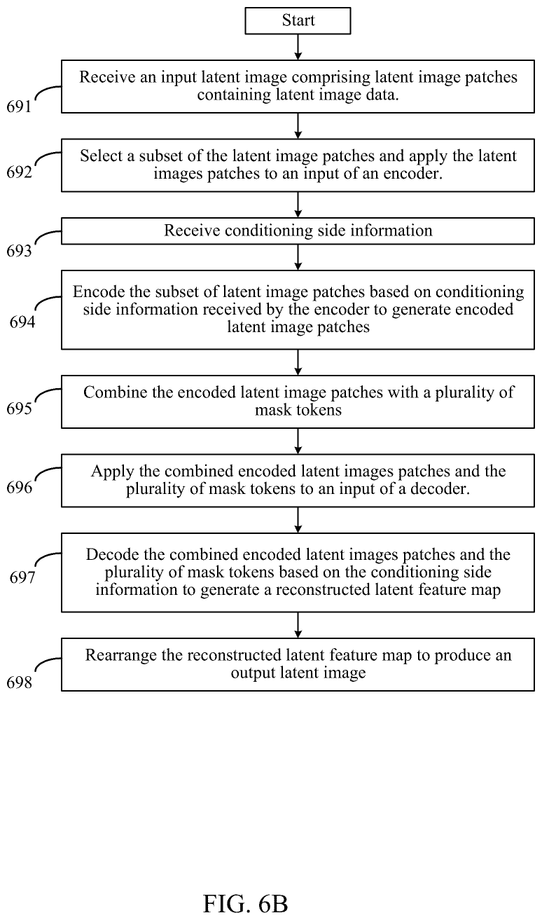

FIG. 6A illustrates a guided latent masked autoencoder (GLMAE) 600 according to an embodiment of the disclosure. The GLMAE 600 may be implemented as a coding device 600 or as a computer vision device 600, among other embodiments. The guided latent MAE context model 600 includes encoder 660, conditioning side information 665, decoder 685, and conditioning side information 680. A latent image 650 is received as an input. The latent image 650 comprises twenty-five (25) latent image patches of latent image data arranged in a 5×5 two-dimensional (2D) array. According to the principles of the present disclosure, in an example embodiment, the latent image 650 may be a latent image y tensor at the output of main encoder 110.

During pre-training, a large random subset of the latent image patches is masked out. These represent the white squares in latent image 650. The small remaining subset 655 of visible patches, labeled A-H, form the input to the encoder 660. Thus, the encoder 660 input is a masked latent feature map. Mask tokens 670 are introduced after the encoder 660 and the full set 675 of encoded patches and mask tokens is processed by a decoder 685 that reconstructs a reconstructed latent image 686 in pixels. Thus, the output is a reconstructed latent feature map. The reconstructed latent image 686 is then rearranged back to a 2D latent image 687.

### Guided Latent MAE Context Model—

In serial and wavefront context models, the coefficients in a latent tensor are predicted and encoded using previously encoded coefficients as a reference (i.e., an anchor). The locations of anchors are predefined and represented by a mask to condition the mask convolution process. However, even though all coefficients are predicted using a mask convolution process in serial and wavefront context model, the prediction accuracy may be limited due to the predefined scan order and fixed anchor locations. In a checkerboard context model, the coefficients may be divided into two even groups using a checkerboard pattern and all coefficients in a first group are used as an anchor to predict all coefficients in the second group. However, even though all coefficients in the second group are predicted using a mask convolution process, the coefficients in the first group may be quantized and entropy coded “as is”—without going through any prediction process. This may result in a suboptimal bit rate reduction. Moreover, these context models may use correlational information as conditioning information, which determines relationships only among locations close to each other. Semantic information has not been used in these context models.

The present disclosure describes a latent masked autoencoder (MAE) or guided latent MAE context model that processes both correlational information and semantic information in a latent tensor. A MAE model may have an asymmetric encoder-decoder architecture. The encoder may be a Vision Transformer (ViT) or a masked Convolution network, while the encoder embeds only a small subset of visible, unmasked patches (without mask tokens) of the original image by a linear projection with added positional embeddings and processes the resulting set to generate a representation that contains semantic information. The decoder embeds the full set of tokens consisting of encoded visible patches, mask tokens, and positional embeddings to all tokens and processes the resulting set to reconstruct the original image. The success of MAE context model is that a high masking ratio is applied to latent image patches during training to make the task sufficiently difficult so that it cannot be easily solved by extrapolation from correlational information among visible neighboring patches and tokens.

The disclosed guided latent MAE context model is a variation of a MAE context model, where conditional side info such as texts and other representations are used as additional inputs to both encoder and decoder. The output Ψ of a previous module can also be used as an additional input for latent MAE context model or a guided latent MAE context model. The latent MAE (or guided latent MAE context model) may be used as an independent context model. Alternatively, it may be used together with channel-grouping or channel-shuffling context model. For each group in channel-grouping or channel-shuffling context model, the present disclosure first selects one or more (or all) channels to form a new tensor and uses the newly formed tensor as the input tensor of MAE. The disclosed method then follows the MAE training procedure, where the encoder embeds only a small subset of visible, unmasked patches (without mask tokens) of the input tensor by a linear projection with added positional embeddings and processes the resulting set to generate a representation that contains semantic information. The decoder embeds the full set of tokens consisting of encoded visible patches, mask tokens and positional embeddings to all tokens and processes the resulting set to reconstruct the input tensor. At test time, for each group in channel-grouping or channel-shuffling context model, the disclosed method may optionally partition the tensor into multiple tiles and process each tile independently.

In one embodiment, an optimal anchor mask is selected based on a rate-distortion (RD) loss function, where the rate is the combined entropy coded information, such as anchor mask, quantized unmasked patches and quantized residual of predicted coefficients. The distortion is the reconstructed latent tensor or reconstructed image.

In another embodiment, the anchor mask may be selected by choosing the anchor mask generated from a previous hyper decoder.

In another embodiment, multiple anchor masks are predefined and one of the anchor masks is selected based on the content distribution of the latent tensor. The index of the selected anchor mask is coded in the bitstream.

Using an independent context model is equivalent to number of group equal to one in channel-grouping or channel-shuffling context model. Optionally one or more items of side information that are used by the MAE encoder are extracted and encoded in bitstream at encoding stage so that they can be used to guide the MAE decoder at decoding stage.

FIG. 6B is a flow diagram of an image processing method implemented by a guided latent masked autoencoder (GLMAE) 600 according to an embodiment of the disclosure. In 691, the coding device receives an input latent image comprising latent image patches containing latent image data. In 692, the coding device selects a subset of the latent image patches and applies the latent image patches to an input of a first encoder. In 693, the coding device receives conditioning side information. In 694, the coding device encodes the subset of latent image patches based on conditioning side information received by the first encoder to generate encoded latent image patches. In 695, the coding device combines the encoded latent image patches with a plurality of mask tokens. In 696, the coding device applies the combined encoded latent image patches and the plurality of mask tokens to an input of a decoder. In 697, the coding device decodes the combined encoded latent image patches and the plurality of mask tokens based on the conditioning side information to generate a reconstructed latent feature map. In 698, the coding device rearranges the reconstructed latent feature map to produce an output latent image.

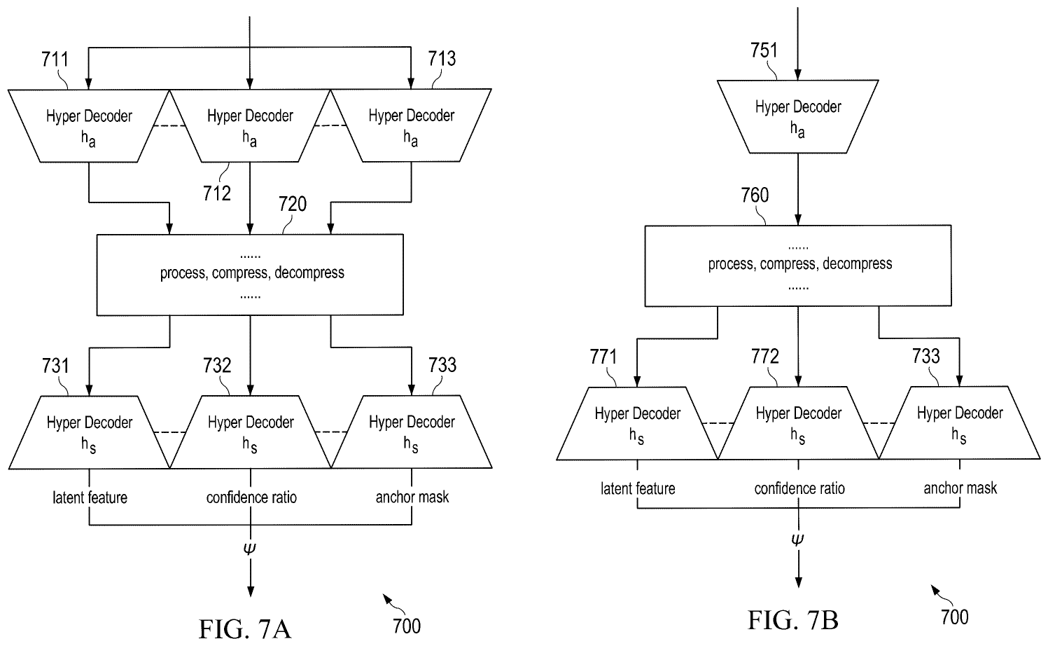

FIGS. 7A-7B illustrate hyper encoder and hyper decoder pairs that produce side information according to an embodiment of the disclosure. Current hyper encoder/decoder pairs include only one encoder and one decoder that take a latent tensor z as input and output a reconstructed latent tensor 2.

In an embodiment, the disclosed system 100 may include one or more additional encoders and decoders to produce one or more items of side information. Examples of side information include a confidence ratio that represents the accuracy between the input latent tensor z and reconstructed latent tensor 2 or an anchor mask that represents the guided mask for checkerboard context model, or the like.

By way of example, FIG. 7A depicts a hyper encoder/decoder system that includes a set of hyper encoders 711-713 that receive a common input tensor and generate three outputs that are applied to a processing unit 720. The outputs of the processing unit 720 are applied to a set of hyper decoders 731-733 that produce outputs that represent side information. Hyper decoder 731 outputs a latent feature, hyper decoder 732 outputs a confidence ratio value, and hyper decoder 733 outputs an anchor mask.

In an embodiment, the disclosed system 100 may include a single-base-multi-head structure, wherein some or all decoder heads share one base encoder. By way of example, FIG. 7B depicts a hyper encoder/decoder system that includes a single hyper encoder 751 that receives an input tensor and generates an output that is applied to a processing unit 760. The output of the processing unit 760 is applied to a set of hyper decoders 771-773 that output side information. Hyper decoder 771 outputs a latent feature, hyper decoder 772 outputs a confidence ratio value, and hyper decoder 773 outputs an anchor mask.

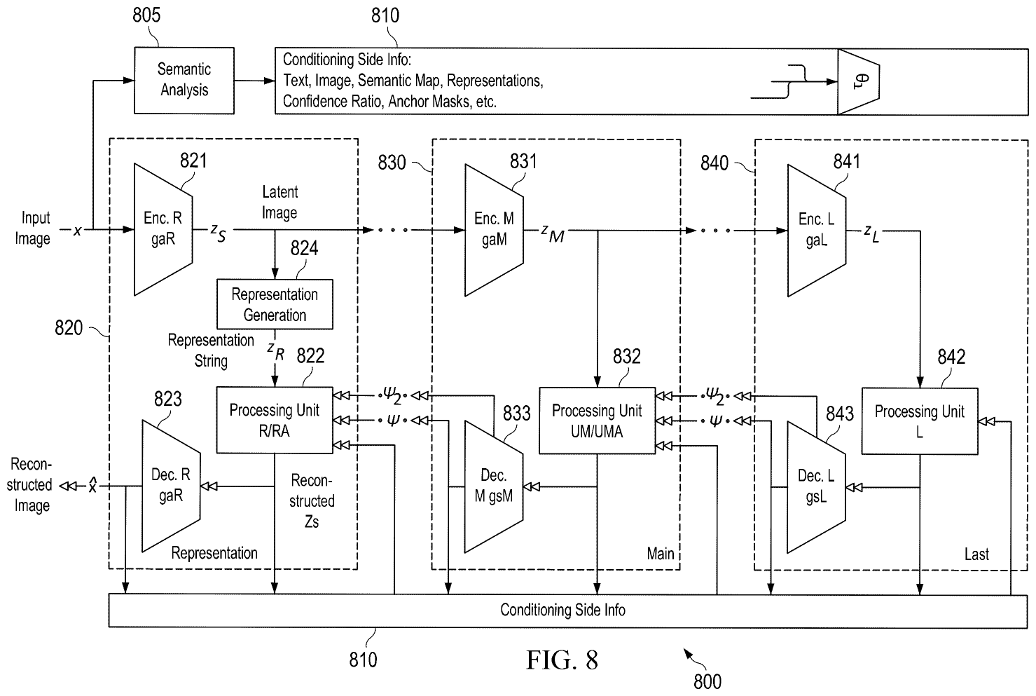

FIG. 8 illustrates a representation-based U-Net structure in a learned image compression framework 800 according to an embodiment of the disclosure. The framework 800 includes a semantic analysis module 805 that produces conditioning side information 810, similar to FIG. 5. It also includes a representation module 820, a main encoder/decoder pair 830, and one or more hyper encoder/decoder pairs, including a last hyper encoder/decoder pair last hyper encoder/decoder pair 840.

The main encoder/decoder pair 830 includes a main encoder 831, a processing unit 832, and a main decoder 833. The last hyper encoder/decoder pair 840 includes a hyper encoder 841, a processing unit 842, and a hyper decoder 843. The representation module 820 includes an encoder (gaR) 821, a representation generation unit 824, a processing unit 822, and a decoder (gsR) 823. The processing units 822, 832, and 842 are similar to the processing units 115 and 135 in FIG. 1. Each of the processing units 822, 832, 842 receives as input(s) conditioning side information 810 and also outputs conditioning side information 810. Each of the processing units 822, 832 also receives as input(s) the outputs (Ψ, Ψ2) of the decoder 833, 843 from the previous stage in FIG. 8. The final main decoder 523 outputs a reconstructed latent image tensor x.

The representation module 820 is used to add skip connections to one or more down-sampling and up-sampling pairs so that each decoder has additional information to reconstruct an image. Because the size of skip tensor may be large, the representation generation unit 824 convert it to a much smaller representation before it is transferred to a decoder. The representation generation unit 824 converts the skip tensor to a highly compact skip representation. This skip representation is quantized, encoded, decoded, and concatenated by processing unit 822 with features from prior up-sampling operations to recover more feature-rich information.

There are numerous methods to convert a skip tensor to a highly compact skip representation. One method is to use contrastive learning to generate a small representation vector that contains 128, 256 or 512 numbers. Another method is to use a VQ method to generate a codebook and then convert the multi-channel tensor element to one codebook indices (8-bit or 10-bit integers).

In an embodiment, the disclosed system 100 may use a representation-based U-Net structure in a learned image compression framework by adding skip connections to one or more down-sampling and up-sampling pairs, effectively converting the main encoder from a VAE structure to a U-Net structure. The U-Net structure includes a contracting path and an expansive path. The contracting path consists of multiple convolutions followed by a rectified linear unit (ReLU) and a down-sampling operation. The expansive pathway concatenates features from up-sampling operation and high-resolution features from the contracting path via skip connections to recover more feature-rich information.

Variational autoencoders (VAEs) are widely used as a main encoder in autoregressive scale hyperprior frameworks of learned image compression. In such a framework, a VAE is used as main encoder to process the latent information of an input image and a hyperprior model is used as a hyper encoder to process additional hyper latent information. The major structural difference between a VAE and a U-Net is that the U-Net contains a skip connection between the down-sampling and up-sampling pair. Such skip connections may provide a path to transfer to the decoder additional information that is lost in down-sampling operations. Due to the size of the tensor used in a skip connection, it is too expensive for image and video compression tasks to encode and save the skip tensor in a bitstream. However, the disclosed system converts the original skip tensor to a highly compact representation and encodes and saves it in the bitstream.

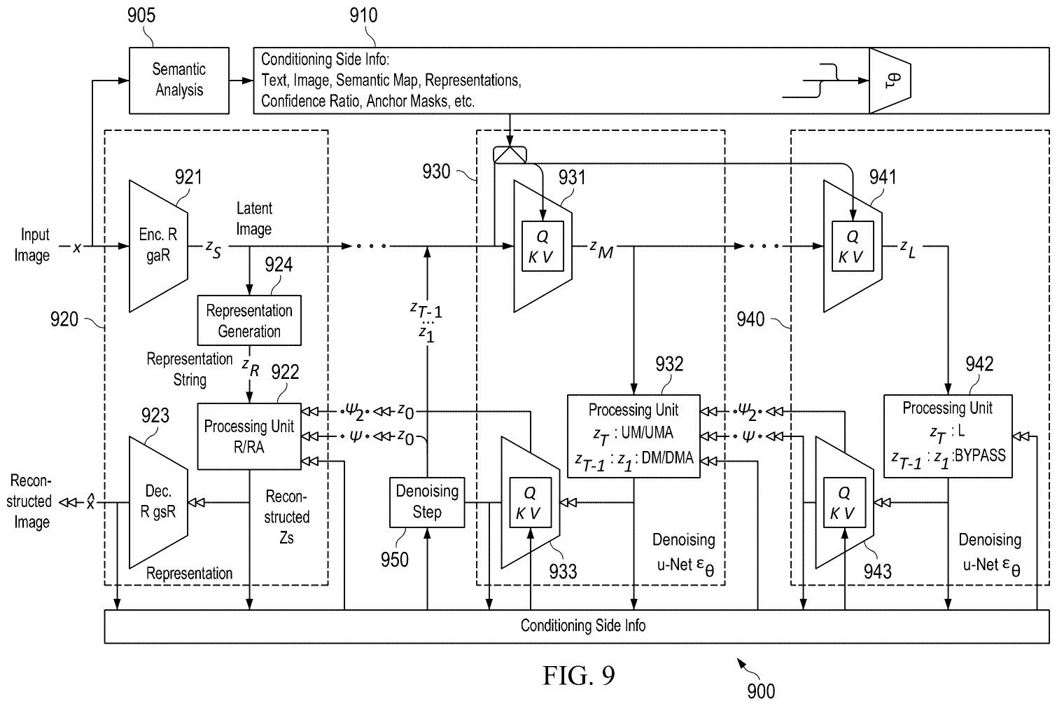

FIG. 9 illustrates a representation diffusion U-Net framework 900 according to an embodiment of the disclosure. The framework 900 includes a semantic analysis module 905 that produces conditioning side information 910, similar to FIG. 5. It also includes a representation module 920, a denoising U-Net module 930, a last denoising U-Net module 940, and a denoising step 950. The representation module 920 includes an encoder (gaR) 921, a representation generation unit 924, a processing unit 922, and a decoder (gsR) 923. The processing units 922, 932, and 942 are similar to the processing units 115 and 135 in FIG. 1. Denoising U-Net module 930 includes a cross-attention encoder 931, a processing unit 932, and a cross-attention decoder 933. Denoising U-Net module 940 includes a cross-attention encoder 941, a processing unit 942, and a cross-attention decoder 943.

Because a diffusion model uses U-Net as its basic model structure, if the diffusion model is used by an enhance module in the processing units, it is possible to harmonize these two U-Net structures together so that a reverse diffusion process can be executed using part of the representation U-Net framework. The present disclosure describes a representation-based Diffusion U-Net structure in learned image compression framework by performing reverse diffusion module using the encoder/decoder pair M and L in representation U-Net framework.

The last processing units (PU L) are used to quantize, encode, and decode the latent tensor zL. Hyper decoder (hsL) 543 uses the decoded latent tensor [symbol] as an input and generates its output Ψ to estimate gaussian parameters that provide the correct probability estimates for [symbol] or [symbol] of the next module. Using the estimated gaussian parameters generated from the output P of the previous module as an additional input, processing unit M (PU M) 532 in hyper encoder/decoder pair is used to predict, quantize, encode, and decode latent tensor zH. The hyper decoder (hs) uses the decoded latent tensor [symbol] as an input and generates its output Ψ to estimate gaussian parameters that provide the correct probability estimates for [symbol] or [symbol] of the next module.

Using the estimated gaussian parameters from the output P of the previous module as and additional input, PU M 532 in the main encoder/decoder pair is used to predict, quantize, encode, and decode latent tensor zM. The main decoder (gs) 523 uses the decoded tensor [symbol] as input and generates the reconstructed image x.

The present disclosure proposes to use one or more semantic items of information as additional inputs during the context modelling process to guide the context model to generate more accurate predictions. The present disclosure includes an optional enhance module in PU M 532 and PU L 542 and uses one or more items of semantic information as additional inputs for the enhance module to partially recover the information loss from transforms, down-sampling, and quantization process at the encoding stage. An enhance module at the encoding stage can optionally output one or more control parameters as side information so that these control parameters can be used by an enhance module at a decoding stage.

In another embodiment, the enhance module can be constructed by using a diffusion process, such as denoising diffusion probabilistic models (DDPM), denoising diffusion implicit models (DDIM), or latent diffusion model (LDM). The information loss from transform, down-sampling, and quantization process at encoding stage can be regarded as the forward diffusion process where the degraded latent tensor is generated by adding noises iteratively. For reverse diffusion process at encoding stage, a trained diffusion neural network, optionally uses semantic side information as additional input, is used to predict the added noise during the forward diffusion process, the original latent tensor is recovered by running the noise removing reverse diffusion process multiple times. One or more control parameters used by reverse diffusion processing at encoding stage, such as iteration time T, diffusion parameter αₜ and βₜ, are saved in bitstream as side information so that they can be used by reverse diffusion processing at decoding stage.

Using the estimated gaussian parameters generated from the output P of previous module as additional input, processing unit (PU) UM in encoder/decoder pair M is used to predict, quantize, encode, and decode latent tensor zM. In PU UM, A skip fusion module is added before an optional enhance module to concatenate [symbol] with the output Ψ of previous module. To process the predicted latent tensor [symbol] during gaussian parameters estimation process, an optional prediction attention module is added before prediction fusion module to concatenate predicted [symbol] with the output Ψ2 of previous module, Ψ2 can be the input tensor of the up-sampling convolution from previous module and used as gating tensor to analyze both the activations and contextual information. PU UMA is a variation of PU UM where a skip attention module is added before the skip fusion module to explore the important areas in [symbol] . Decoder M uses the enhanced version of decoded tensor [symbol] as input and generates its output Ψ to estimate gaussian parameters that provides the correct probability estimates for [symbol] of next module. Processing unit (PU) R in encoder/decoder pair R is used to quantize, encode, and decode the skip representation zR. In PU S, a skip fusion module is added before an optional enhance module to concatenate the expanded representation [symbol] with the output Ψ of previous module.

Prediction attention and Skip attention modules can use different network architectures, or they can share the same network architecture. In one embodiment, to determine the focus regions of input feature x1, a gating tensor g is used to analyze both the activations and contextual information. Features x1 and g are concatenated together and linearly mapped to an intermediate space. After a channel-wise 1×1×1 convolution, a sigmoid function is used to normalize the attention coefficients σ2. A grid-attention technique is used where gating signal is a grid signal conditioned to image spatial information. Input features x1 are then scaled with attention coefficients α computed in Attention Gate.

The disclosed system proposes to execute one iteration to generate degraded tensor representation [symbol] using original PU UM/UMA and PU L in representation U-Net framework before first reverse diffusion iteration. After that, the reverse diffusion process is executed to recover the original latent tensor zS by using PU DM/DMA and bypassing PU L. PU DM/DMA is a simplified version of PU UM/UMA where the quantization, decoding, and decoding module in PU UM/UMA are skipped as they are not needed for reverse diffusion process. In one embodiment, the present disclosure proposes to use independent skip attention and skip fusion module for PU DM/DMA. In another embodiment, the present disclosure proposes to share the skip attention and skip fusion module in PU UM/UMA for PU DM/DMA. One or more control parameters used by reverse diffusion process at encoding stage, such as iteration time T, diffusion parameter αₜ and βₜ, are saved in bitstream as side information so that they can be used by reverse diffusion process at decoding stage.

For iteration t=T, the disclosed system proposes to execute one iteration to generate zt=T, the output of Denoising U-Net module 930, using original PU UM/UMA 932 and PU L 942 in Denoising U-Net module 930 and Denoising U-Net module 940 of representation U-Net framework 900, for the first reverse diffusion iteration.

After that, for iteration t equals T−1 to 1, the disclosed system proposes to feed zt=[T−1, 1], the output of Denoising U-Net module 930, back to Denoising U-Net module 930 and generate zt−1=[T−2,0] using PU DM/DMA 932 and bypassing PU L 942. This process is repeated T−1 times until final denoised output z0 is generated.

After that, the final denoised output z0 is send to PU R/RA 922, together with the output of skip representation zR from Representation Generation 924, the output Ψ of previous module 933, and other side information, to generate reconstructed tensor representation \hat{z}ₛ.

One or more control parameters used by reverse diffusion process at encoding stage, such as iteration time T, diffusion parameter αₜ and βₜ, are saved in bitstream as side information so that they can be used by reverse diffusion process at decoding stage.

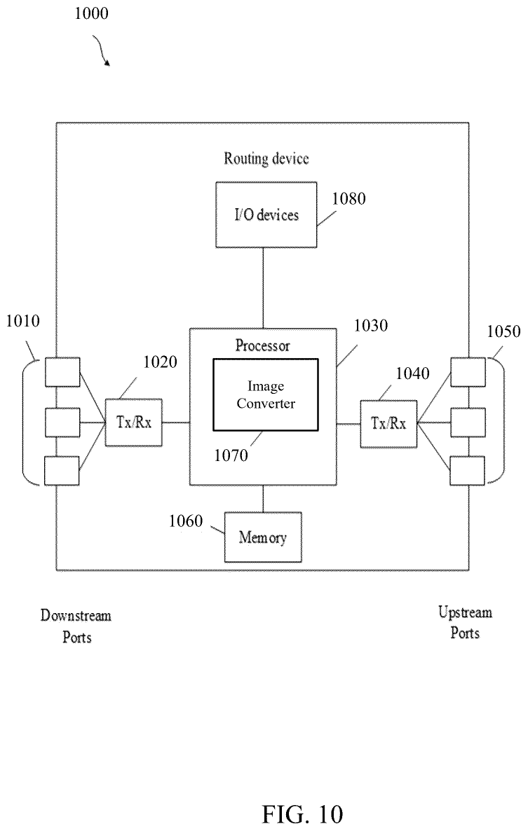

FIG. 10 is a schematic diagram of a routing device 1000 according to an embodiment of the disclosure. The routing device 1000 is suitable for implementing the disclosed embodiments as described herein. In an embodiment, the routing device 1000 may be a router, a switch, a node, or another communication device configured to process Internet traffic.

The routing device 1000 comprises ingress ports 1010 (or input ports 1010) and receiver units (Rx) 1020 for receiving data; one or more processors, logic units, or central processing units (CPUs) 1030 to process the data; transmitter units (Tx) 1040 and egress ports 1050 (or output ports 1050) for transmitting the data; and a memory 1060 for storing the data. The routing device 1000 may also comprise optical-to-electrical (OE) components and electrical-to-optical (EO) components coupled to the ingress ports 1010, the receiver units 1020, the transmitter units 1040, and the egress ports 1050 for egress or ingress of optical or electrical signals.

The one or more processors 1030 are implemented by hardware and software. The processor(s) 1030 may be implemented as one or more CPU chips, cores (e.g., as a multi-core processor), field programmable gate arrays (FPGAs), application specific integrated circuits (ASICs), and digital signal processors (DSPs). The processor(s) 1030 is in communication with the ingress ports 1010, receiver units 1020, transmitter units 1040, egress ports 1050, and memory 1060.

The processor(s) 1030 comprises an image converter 1070. The image converter 1070 implements the disclosed embodiments described above. The image converter 1070 provides the various coding devices, encoders, decoders, convolution operations, frameworks, and the like. The image converter 170 may implement latent channel reorder, a channel-shuffling context model, a semantic variational autoencoder (VAE) framework, a guided masked autoencoder (MAE) context model, a representation U-Net framework, and/or a representation diffusion U-Net framework. The inclusion of the image converter 1070 therefore provides a substantial improvement to the functionality of the routing device 1000 and effects a transformation of the routing device 1000 to a different state. Alternatively, the image converter 1070 may be implemented as instructions stored in the memory 1060 and executed by the processor 1030.

The memory 1060 may comprise one or more disks, tape drives, and solid-state drives and may be used as an over-flow data storage device, to store programs when such programs are selected for execution, and to store instructions and data that are read during program execution. The memory 1060 may be, for example, volatile and/or non-volatile and may be a read-only memory (ROM), random access memory (RAM), ternary content-addressable memory (TCAM), and/or static random-access memory (SRAM).

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of image processing implemented by a coding device comprising:
receiving an input latent image comprising latent image patches containing latent image data;
selecting a subset of the latent image patches;
applying the latent image patches to an input of a first encoder in the coding device;
receiving conditioning side information;
encoding, by the first encoder, the subset of latent image patches based on the conditioning side information to generate encoded latent image patches;
combining the encoded latent image patches with a plurality of mask tokens;
applying the combined encoded latent image patches and the plurality of mask tokens to an input of a decoder in the coding device;
decoding, by the decoder, the combined encoded latent image patches and the plurality of mask tokens based on the conditioning side information to generate a reconstructed latent feature map; and
rearranging the reconstructed latent feature map to produce an output latent image.

2. The method of claim 1, wherein the input latent image comprises a latent image tensor received from a second encoder.

3. The method of claim 1, wherein the input latent image comprises N latent image patches arranged in a two-dimensional (2D) array.

4. The method of claim 3, wherein the 2D array is an M×M array.

5. The method of claim 4, wherein selecting the subset of the latent image patches comprises masking out, by the first encoder, a plurality of the latent image patches in the M×M array.

6. The method of claim 1, wherein applying the latent image patches to the input of the first encoder comprises applying unmasked latent image patches to the input of the first encoder.

7. The method of claim 1, wherein the conditioning side information comprises semantic information.

8. The method of claim 1, wherein the conditioning side information comprises at least one of text data, image data, or a semantic map.

9. The method of claim 1, wherein the conditioning side information comprises at least one of representation data, confidence ratio data, or an anchor mask, or other information that represents a semantic information of input latent image.

10. An apparatus for processing images, comprising:
a storage device; and
one or more processors coupled to the storage device and configured to execute instructions on the storage device such that when executed, cause the apparatus to:
receive an input latent image comprising latent image patches containing latent image data;
select a subset of the latent image patches;
apply the latent image patches to an input of a first encoder in the apparatus;
receive conditioning side information encode, by the first encoder, the subset of latent image patches based on the conditioning side information to generate encoded latent image patches;
combine the encoded latent image patches with a plurality of mask tokens;
apply the combined encoded latent image patches and the plurality of mask tokens to an input of a decoder in the apparatus;
decode, by the decoder, the combined encoded latent image patches and the plurality of mask tokens based on the conditioning side information to generate a reconstructed latent feature map; and
rearrange the reconstructed latent feature map to produce an output latent image.

11. The apparatus of claim 10, wherein the input latent image comprises a latent image tensor received from a second encoder.

12. The apparatus of claim 10, wherein the input latent image comprises N latent image patches arranged in a two-dimensional (2D) array.

13. The apparatus of claim 12, wherein the 2D array is an M×M array.

14. The apparatus of claim 13, wherein the apparatus selects the subset of the latent image patches by masking out, by the first encoder, the plurality of the latent image patches in the M×M array.

15. The apparatus of claim 10, wherein the apparatus applies the latent image patches to the input of the first encoder by applying unmasked latent image patches to the input of the first encoder.

16. The apparatus of claim 10, wherein the conditioning side information comprises semantic information.

17. The apparatus of claim 10, wherein the conditioning side information comprises at least one of text data, image data, or a semantic map.

18. The apparatus of claim 10, wherein the conditioning side information comprises at least one of representation data, confidence ratio data, or an anchor mask, or other information that represents a semantic information of the input latent image.

19. A network device for communication between nodes, comprising:
a storage device; and
one or more processors coupled to the storage device and configured to execute instructions on the storage device such that when executed, cause the one or more processors to:
receive an input latent image comprising latent image patches containing latent image data;
select a subset of the latent image patches;
apply the latent image patches to an input of a first encoder in the network device;
receive conditioning side information;
encode, by the first encoder, the subset of latent image patches based on the conditioning side information to generate encoded latent image patches;
combine the encoded latent image patches with a plurality of mask tokens;
apply the combined encoded latent image patches and plurality of mask tokens to an input of a decoder in the network device;
decode, by the decoder, the combined encoded latent image patches and plurality of mask tokens based on the conditioning side information to generate a reconstructed latent feature map; and
rearrange the reconstructed latent feature map to produce an output latent image.

20. The network device of claim 19, wherein the input latent image comprises a latent image tensor received from a second encoder.
